(19) United States
(12) Patent Application Publication
(10) Pub. No.: US 2013/0071633 A1
(43) Pub. Date: Mar. 21, 2013

(54) Short Fiber Reinforced Artificial Stone Laminate

(71) Applicant: Gosakan Aravamudan, Bangalore (IN)

(72) Inventor: Gosakan Aravamudan, Bangalore (IN)

(21) Appl. No.: 13/700,133

(22) PCT Filed: May 25, 2011
(86) PCT No.: PCT/IN2011/000360

§ 371 Date: Nov. 27, 2012

(30) Foreign Application Priority Data
May 28, 2010 (IN) 1463/CHE/2010

(51) Int. Cl. B32B 5/30; B32B 19/02; B05D 5/00

(52) U.S. Cl. CPC B32B 5/30; B05D 5/00; B32B 19/02
USPC 428/196; 427/201; 428/206; 428/208

(57) ABSTRACT

A short fiber reinforced artificial stone laminate comprising a top layer of particulates of substantially a single size between 0.5 mm and 3 mm, short fibers deposited in grooves between the particulates, a rear layer of long reinforcing fibers backing the particulates and the short fibers, and a binder is provided. A method for manufacturing the short fiber reinforced artificial stone laminate is also provided. Particulates, for example, quartz particulates, are deposited on a release surface. Short fibers, for example, short glass fibers, are deposited in grooves between the particulates. The particulates and the short fibers are vibrated, whereby the short fibers align and position themselves in the grooves. Long reinforcing fibers are then deposited on the particulates. A binder is deposited for binding the particulates, the short fibers, and the long reinforcing fibers. After the binder cures, the surface of the particulates is polished.

### CROSS REFERENCE TO RELATED APPLICATIONS

This application claims the benefit of the following patent applications:

1. Provisional patent application number 1463/CHE/2010 titled “Top Layer Reinforced Quartz And Fiber Composite” filed on May 28, 2010 in the Indian Patent Office.

2. PCT application number PCT/IN2011/000360 titled “Short Fiber Reinforced Artificial Stone Laminate” filed on May 25, 2011 in the Indian Patent Office.

The specifications of the above referenced patent applications are incorporated herein by reference in their entirety.

### BACKGROUND

This invention, in general, relates to building structures. More particularly, this invention relates to an architectural surface for furniture and building structures.

Currently, decorative laminates and wood veneers are extensively used as architectural surfaces. In most cases, decorative laminates are manufactured from kraft paper impregnated with phenolic resin. Wood and its derivatives are currently the preferred choice of material for surfacing furniture and building structures. Wood veneers and wood derived products such as laminates place a large burden on our already shrinking environmental resources.

Decorative laminates show scratches over prolonged use, and uncoated wood veneers absorb moisture and stain easily. If proper care is not taken, wood products have a limited life. Wood products may decay when exposed to moisture for long periods, and are prone to termite attacks. In tropical countries with excess rainfall, wood expands seasonally due to excess moisture content. As a result, doors and windows surfaced with wood or its derivatives get jammed within their frames.

Engineered stone is currently manufactured in various thicknesses, for example, of thickness 12 mm. Such engineered stone is not currently used as a thin architectural surface laminate, for example, in laminate applications such as surfacing on wooden boards. Architectural laminates need to be of a thickness of approximately 1 mm to 3 mm.

Hence, there is a need for an artificial stone laminate, where the total thickness of the artificial stone laminate is approximately 1 mm to 3 mm. Moreover, there is a need to improve the resistance to delamination of a quartz layer from a glass fiber layer in the above mentioned artificial stone laminate. Furthermore, there is a need to improve the resistance to surface crack propagation in the top quartz layer and improve the bending strength of the overall artificial stone laminate.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The artificial stone laminate disclosed herein overcomes the drawbacks of wood derived architectural surfaces. The artificial stone laminate disclosed herein has a very high abrasion resistance and is waterproof. Hence, the artificial stone laminate disclosed herein remains intact even with prolonged exposure to environmental conditions while retaining its aesthetic appearance for a considerable period of time.

The short fiber reinforced artificial stone laminate disclosed herein is also referred to as a top layer reinforced quartz and fiber composite and has a total thickness of, for example, about 1 mm to about 3 mm. The short fiber reinforced artificial stone laminate disclosed herein also improves the resistance to surface crack propagation in a top layer of quartz particulates and improves the bending strength of the overall short fiber reinforced artificial stone laminate.

The short fiber reinforced artificial stone laminate disclosed herein comprises a top layer of particulates, for example, quartz particulates; strands of short fibers, for example, short glass fibers deposited in grooves or rear cavities between the particulates; a rear layer of long reinforcing fibers backing the particulates and the short fibers; and a binder, for example, a binding resin that binds the particulates, the short fibers, and the long reinforcing fibers. The short glass fibers improve the resistance to delamination of the layer of quartz particulates from the layer of long reinforcing fibers.

Disclosed herein is a method for manufacturing a short fiber reinforced artificial stone laminate. Particulates, for example, quartz particulates, are deposited on a release surface. Short fibers, for example, short glass fibers are deposited in grooves between the particulates. Each of the short fibers is of a length, for example, between about 1 mm and about 6 mm. The particulates and the short fibers are vibrated, whereby the short fibers align and position themselves in the grooves between the particulates. Long reinforcing fibers are deposited on the particulates, for example, in the form of a chopped glass fiber mat for backing the particulates and the short fibers. The long reinforcing fibers are, for example, configured as a chopped glass fiber mat. In an embodiment, the long reinforcing fibers are configured as a knitted glass fiber yarn. A binder, for example, a polyester resin, is then deposited for binding the particulates, the short fibers, and the long reinforcing fibers.

One or more of the following processes are applied to compact and remove air bubbles and set the short fiber reinforced artificial stone laminate. In an embodiment, a vibrator is used in one or more stages of the method for manufacturing the short fiber reinforced artificial stone laminate disclosed herein to bring the particulates closer together, to provide a greater area of particulate coverage on the surface, to release entrapped air, and to improve compaction. In another embodiment, a compaction load of, for example, about 2 kg/sq. cm, is applied through a vacuum or a hydraulic press to compact the short fiber reinforced artificial stone laminate. In another embodiment, a vacuum is applied to the deposited material to remove entrapped air.

A surface of the single layer of particulates is polished until the substantially largest sectional area of the particulates is exposed. Furthermore, the method disclosed herein comprises application of vacuum and pressure to the deposited binder, the single layer of particulates, and the layer of long reinforcing fibers during and/or after the deposition of the binder. The surface of the single layer of the particulates is modified chemically for improved adhesion of the particulates with the binder.

The top single layer of particulates is of substantially a single size. The size deviation from the single size of the particulates is restricted to, for example, plus or minus 40%. The single size of the particulates is chosen, for example, between about 0.5 mm and about 3 mm. Each of the particulates has an exposed top flat surface section area. The exposed top flat surface section area of each of the particulates is substantially the largest sectional area that can be exposed in the particulates. The particulates comprise, for example, quartz particulates, or one or more of quartz particulates, metal pieces, transparent particulates coated with metal and colored glass, and any combination thereof. The reinforcing fibers comprise, for example, glass fibers. The rear layer of the reinforcing fibers is, for example, a knitted glass fiber yarn. The binder is, for example, a polyester resin with a filler, an acrylic resin, etc.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 exemplarily illustrates a short fiber reinforced artificial stone laminate.

FIG. 2 exemplarily illustrates particulates deposited on a release surface.

FIG. 3 exemplarily illustrates short fibers deposited in grooves between the particulates.

FIG. 4 exemplarily illustrates long reinforcing fibers deposited over the particulates.

FIG. 5 exemplarily illustrates the short fiber reinforced artificial stone laminate inverted for polishing.

FIG. 6 exemplarily illustrates a method for manufacturing a short fiber reinforced artificial stone laminate.

### DETAILED DESCRIPTION OF THE INVENTION

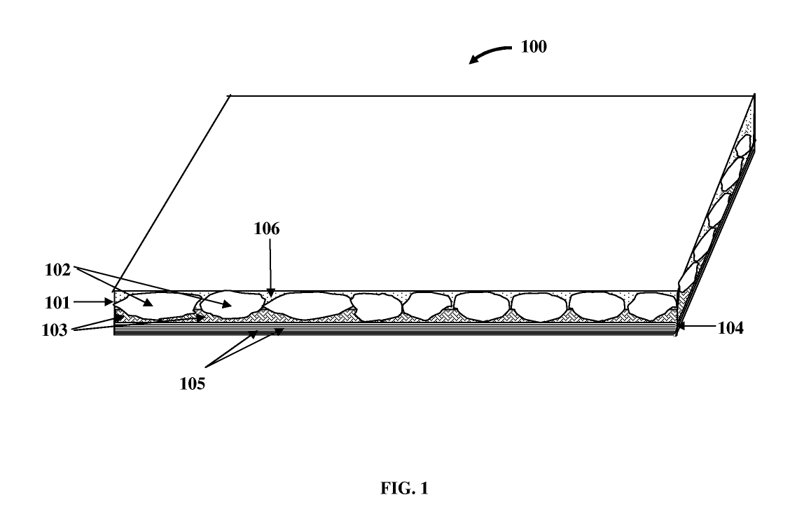

FIG. 1 exemplarily illustrates a short fiber reinforced artificial stone laminate 100. The short fiber reinforced artificial stone laminate 100 disclosed herein can be used, for example, as a decorative laminate comprising a visually decorative and functional surface covering. Decorative laminates are required to be thin and flexible to be used as an architectural surface covering, as heavier and thicker decorative laminates pose difficulty in adhering to substrates. Thicker and heavier decorative laminates may delaminate and warp over time. The short fiber reinforced artificial stone laminate 100 disclosed herein comprises a single layer 101 of particulates 102 that is lightweight and visually appeasing. Furthermore, since the short fiber reinforced artificial stone laminate 100 disclosed herein requires no more than a single layer 101 of particulates 102, there is substantial reduction, for example, in cost, thickness, and weight resulting in a thin lightweight short fiber reinforced artificial stone laminate 100.

The short fiber reinforced artificial stone laminate 100 disclosed herein comprises a top layer 101 of particulates 102, short fibers 103 deposited in grooves 107 between the particulates 102, a rear layer 104 of long reinforcing fibers 105 backing the particulates 102 and the short fibers 103, and a binder 106 binding the particulates 102, the short fibers 103, and the long reinforcing fibers 105.

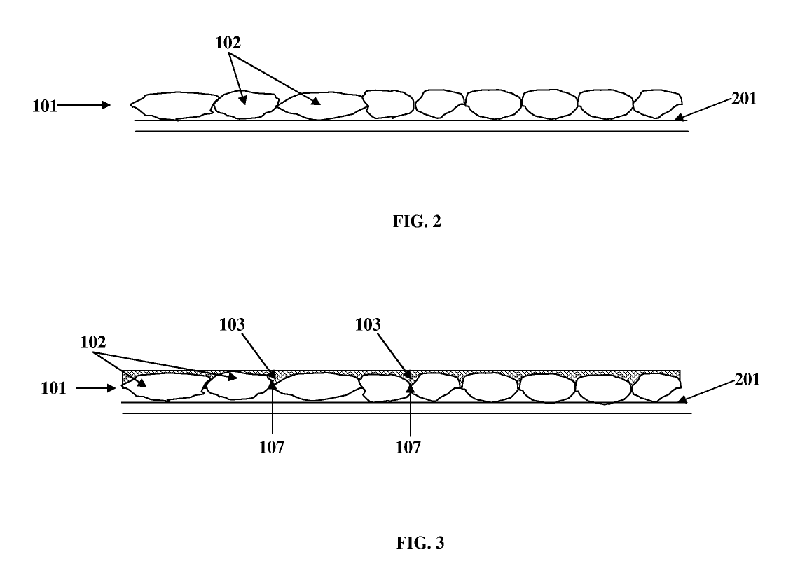

FIG. 2 exemplarily illustrates the particulates 102 deposited on a release surface 201. A single layer 101 of particulates 102 is deposited on the release surface 201, for example, a silicon rubber sheet, Teflon® of DuPont, a Mylar® sheet, etc. The particulates 102 comprise, for example, one or more of quartz particulates, metal pieces, transparent particulates coated with metal and colored glass, and any combination thereof. The particulates 102 are of a substantially single size. The size deviation from the single size of the particulates 102 is restricted to, for example, plus or minus 40%. The single size of the particulates 102 is chosen, for example, between about 0.5 mm and about 3 mm. In addition to the particulates 102, the top layer 101 of the short fiber reinforced artificial stone laminate 100 further comprises particles such as glass, stone, semiprecious stone, metal, ceramic, and other decorative particles and objects.

FIG. 3 exemplarily illustrates short fibers 103 deposited in grooves 107 between the particulates 102. The short fibers 103, for example, short glass fibers, are deposited in the grooves 107 or rear cavities between the particulates 102. Each of the short fibers 103 is of a length, for example, between about 1 mm and about 6 mm. On vibrating the particulates 102 and the short fibers 103, the short fibers 103 align and position themselves in the grooves 107 between the particulates 102. The short fibers 103 deposited in the grooves 107 between the particulates 102, for example, quartz particulates, improve the resistance to crack propagation in the surface layer 101 of particulates 102, improve resistance to delamination of the layer 101 of particulates 102 from the layer 104 of long reinforcing fibers 105, and also improve the overall bending strength of the short fiber reinforced artificial stone laminate 100.

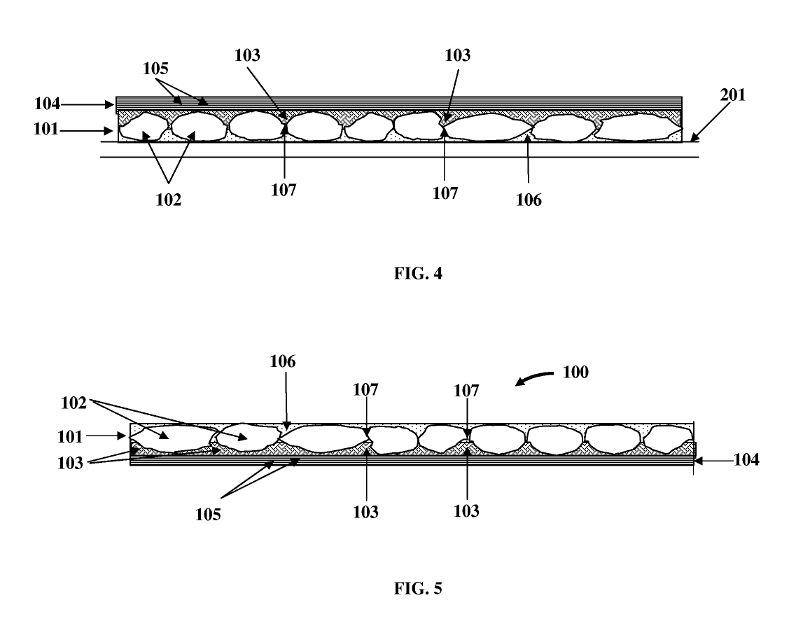

FIG. 4 exemplarily illustrates long reinforcing fibers 105 deposited over the particulates 102. The layer 104 of long reinforcing fibers 105 comprises, for example, one or more of glass fibers, polyester fibers, ceramic fibers, carbon fibers, aramid fibers, organic fibers, etc. In an embodiment, the long reinforcing fibers 105 are configured as a chopped glass fiber mat. In another embodiment, the long reinforcing fibers 105 are configured as a knitted glass fiber yarn. The long reinforcing fibers 105 are deposited over the particulates 102 for backing the particulates 102 and the short fibers 103. In an example, if the size of the quartz particulates 102 is 2 mm, the size of the short glass fibers 103 are, for example, in a range of about 1 mm to about 4 mm. The length of the long reinforcing fibers 105 is, for example, greater than 1 inch. A binder 106 is then introduced for binding the particulates 102, the short fibers 103, and the long reinforcing fibers 105. The binder 106 is, for example, a polyester resin with a filler. The binder 106 is, for example, a polyester resin such as iso neo pentyl glycol (NPG) or ortho neo pentyl glycol along with a monomer such as styrene, and fillers such as aluminum trihydrate. The binder 106 may also be an acrylic resin comprising methyl methyl acrylate (MMA).

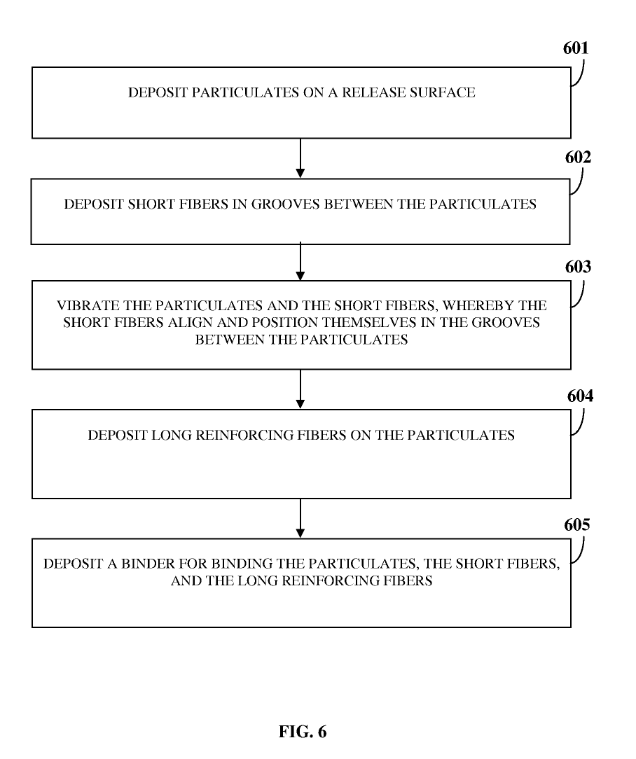

FIG. 5 exemplarily illustrates the short fiber reinforced artificial stone laminate 100 inverted for polishing. After introduction of the binder 106, the short fiber reinforced artificial stone laminate 100 is inverted for polishing. The surface of the single layer 101 of particulates 102 is polished after the binder 106 cures, thereby exposing a large area of the particulates 102 on the surface of the short fiber reinforced artificial stone laminate 100.

Consider an example of manufacturing a short fiber reinforced artificial stone laminate 100. A 2 mm thick layer of the short fiber reinforced artificial stone laminate 100 comprises transparent quartz particulates 102 of size 1.7 mm, short glass fibers 103 of length 3 mm deposited in the grooves 107 between the quartz particulates 102, chopped strand long reinforcing glass fiber mats of density 800 grams per square meter, and a binder 106. The binder 106 comprises, for example, 30% by weight of an aluminum trihydrate fine powder, 38% by weight of isothalic neo pentyl glycol (NPG) with a styrene monomer, 2% by weight of a white pigment, and catalysts.

FIG. 6 exemplarily illustrates a method for manufacturing a short fiber reinforced artificial stone laminate 100. Particulates 102, for example, quartz particulates are deposited 601 on a release surface 201 as exemplarily illustrated in FIG. 2. Short fibers 103, for example, short glass fibers, of length 3 mm are deposited 602 in the grooves 107 between the quartz particulates 102 as exemplarily illustrated in FIG. 3. The quartz particulates 102 and the short glass fibers 103 are vibrated 603, whereby the short glass fibers 103 align and position themselves in the grooves 107 between the quartz particulates 102 as exemplarily illustrated in FIG. 3. In an embodiment, forced air from a compressor is used to blow the short glass fibers 103 into the grooves 107 between the quartz particulates 102. Long reinforcing fibers 105 are deposited 604 on the quartz particulates 102 as exemplarily illustrated in FIG. 4. A binder 106 is deposited 605 on the layer 104 of long reinforcing fibers 105 for binding the quartz particulates 102, the short glass fibers 103, and the long reinforcing fibers 105 as exemplarily illustrated in FIGS. 4-5. In an embodiment, the binder 106 can be deposited on the top single layer 101 of quartz particulates 102 before the deposition of the layer 104 of long reinforcing fibers 105 on the single layer 101 of quartz particulates 102. The binder 106 fills gaps between the quartz particulates 102 and binds the short glass fibers 103 and the long reinforcing fibers 105 to the quartz particulates 102. The binder 106 is deposited on the single layer 101 of quartz particulates 102, for example, by one of the processes of resin transfer molding, tape casting, spraying, etc. The same binder 106 is used for both the top single layer 101 of quartz particulates 102 and the rear layer 104 of long reinforcing fibers 105. The top single layer 101 of quartz particulates 102 and the rear layer 104 of long reinforcing fibers 105 are cast with the binder 106 matrix in situ resulting in the binder 106 matrix being continuous between the two layers 101 and 104.

In an embodiment, a surface of the particulates 102 is chemically modified for improved adhesion of the particulates 102 with the binder 106. In an embodiment, vacuum and pressure are applied to the deposited binder 106, the particulates 102, and the long reinforcing fibers 105 during and/or after the deposition of the binder 106.

One or more of the following processes are applied to compact and remove air bubbles and set the short fiber reinforced artificial stone laminate 100. In an embodiment, a vibrator is used in one or more steps of the method for manufacturing the short fiber reinforced artificial stone laminate 100 disclosed herein to bring the particulates 102 closer together, to provide a greater area of quartz coverage on the surface, to release entrapped air, and to improve compaction. In another embodiment, a compaction load of, for example, about 2 kg/sq. cm is applied through a vacuum or a hydraulic press to compact the short fiber reinforced artificial stone laminate 100. In another embodiment, a vacuum is applied to the deposited material to remove entrapped air.

In addition to the quartz particulates 102, other particulates, for example, glass particles or stone particles may also be added to partially or entirely substitute the quartz particulates 102 in the top layer 101 of particulates 102. The addition of these particulates 102 may result in improved aesthetic qualities. Metal or pigment coated quartz or glass particles may be added to provide improved reflective or colored aesthetics. Colored glass particles may also be added to create artistic patterns or designs on the surface of the short fiber reinforced artificial stone laminate 100.

In an embodiment, small quartz particulates are interspersed in the gaps between the large quartz particulates 102. For example, 0.5 mm quartz particulates are interspersed in the gaps between large 2 mm quartz particulates 102. Furthermore, fine powder aluminum trihydrate may be further added as a filler in the short fiber reinforced artificial stone laminate 100.

In an embodiment, the layer 104 of long reinforcing fibers 105 is configured as a knitted fiber yarn. For example, a three dimensionally knitted glass fiber yarn of thickness greater than 1 mm is overlaid on and then bound to the layer 101 of quartz particulates 102. The size of the loop of the knitted glass fiber yarn may be greater than the size of the large quartz particulates 102 or glass particles. The coarse surface of the knitted glass fiber yarn as well as the cavities between the knits allow for exceptional adhesion between the knitted glass fiber yarn and the quartz particulates 102.

In another embodiment, a lightweight core can be provided as a backing to the layer 104 of long reinforcing fibers 105. Examples of the lightweight core are a polyurethane foam, a honeycomb structure, etc. The honeycomb structure is, for example, a paper honeycomb, a reinforced plastic honeycomb, a plastic honeycomb, an aluminum honeycomb, etc.

The size of the particulates 102 is chosen, for example, between about 0.5 mm and about 3 mm. The preferred size of the particulates 102 is chosen, for example, in the range of about 1.05 mm to about 1.95 mm. The size deviation of the particulates 102 from the single size of the particulates 102 is restricted to, for example, plus or minus 40%. For example, within this range, a substantially single size of the particulates 102 chosen is approximately 1.5 mm. In case the chosen size of the particulates 102 is 1.5 mm, the maximum particulates' 102 size ranges are plus or minus 40%, that is, the actual size of the particulates 102 is in the range of 0.9 mm to 2.1 mm. The particulates 102 are, for example, quartz particulates, or one or more of a combination of quartz particulates, metal pieces, and transparent particulates coated with metal and colored glass. The particulates 102 are preferably transparent quartz particulates. The particulates 102 further comprise, for example, metal or pigment coated quartz or glass particulates that provide improved reflective or colored aesthetics. The particulates 102 further comprise, for example, colored glass particulates that create artistic patterns or designs on the surface of the short fiber reinforced artificial stone laminate 100. All types of particulates 102 are, for example, of substantially the same size. Each of the particulates 102 has an exposed top flat surface section area. After the polishing process, the exposed top flat surface section area of each of the particulates 102 is planar. The exposed top flat surface section area of each of the particulates 102 is, for example, substantially the largest sectional area that can be exposed in the particulates 102.

The transparency of the quartz particulates 102 gives the exposed top flat surface section area of the quartz particulates 102 a rich visual appearance. Furthermore, the quartz particulates 102 provide exceptional scratch resistance. In addition to the quartz particulates 102, other particulates 102 such as glass particulates or stone particulates may also be added on the exposed top flat surface section area of the short fiber reinforced artificial stone laminate 100. The addition of the other particulates 102 to the quartz particulates 102 results, for example, in improved aesthetic qualities.

The short fibers 103 and the long reinforcing fibers 105 comprise, for example, glass fibers. The rear layer 104 of long reinforcing fibers 105 is, for example, a knitted glass fiber yarn and is preferably a glass fiber. The glass fiber may be a chopped strand mat or a knitted fiber. The short fibers 103 and the long reinforcing fibers 105 comprise, for example, one or more of glass fibers, polyester fibers, ceramic fibers, carbon fibers, aramid fibers, organic fibers, etc.

The binder 106 is, for example, a polyester resin with a filler, an acrylic resin, etc. The binder 106 used for filling gaps between the particulates 102 and for binding the long reinforcing fibers 105 to the short fibers 103 and the particulates 102 is, for example, a thermoset plastic such as a polyester resin along with a filler. An example of a polyester resin is a combination of 80% ortho neo pentyl glycol and 20% styrene. Another example of a polyester resin is a combination of isophthalic neo pentyl glycol, methyl methyl acrylate, and styrene. Room temperature catalysts such as methyl ethyl ketone peroxide (MEKP) and room temperature accelerators may be used along with the binder 106 for curing the binder 106. High temperature setting catalysts such as benzoyl peroxide (BPO) may also be used for curing the binder 106. The filler is a fine powder, for example, aluminum trihydrate, calcium carbonate, quartz powder, etc., or a combination thereof. The use of aluminum trihydrate as a filler makes the short fiber reinforced artificial stone laminate 100 disclosed herein fire resistant.

Decorative material may be embedded within the single layer 101 of particulates 102. The decorative material comprises, for example, one or more of ornamental glass, a quartz composite, semiprecious stone, metal art, colored quartz, glass jewelry, stone jewelry, etc. The decorative material is placed on a release surface 201, for example, on a Teflon® release sheet. The decorative material, for example, large quartz particulates 102 are deposited on the Teflon® release sheet. The large quartz particulates 102 may be treated with an organofunctional coupling agent for better adhesion between the large quartz particulates 102, and the binder 106 and the long reinforcing fibers 105. The binder 106 is, for example, a polyester resin. The organofunctional coupling agent is, for example, an organofunctional silane. The release surface 201 is vibrated whereby the large quartz particulates 102 are packed closely and achieve high surface coverage. The binder 106, for example, the polyester resin is deposited with a high concentration of solid filler. The binder 106 fills the gaps between the large quartz particulates 102. A layer 104 of long reinforcing fibers 105 is placed on the single layer 101 of large quartz particulates 102, wherein the binder 106 binds the long reinforcing fibers 105 to the single layer 101 of large quartz particulates 102. The surface of the single layer 101 of large quartz particulates 102 is polished along with the decorative work after the binder 106 cures, thereby exposing a large area of the large quartz particulates 102 on the surface of the short fiber reinforced artificial stone laminate 100.

The release surface 201 is, for example, silicon rubber sheets, Teflon® of DuPont, Mylar® sheets, etc. The release surface 201 may also be treated with release coatings, for example, polyvinyl alcohol or silicone sprays. In the short fiber reinforced artificial stone laminate 100 disclosed herein, some or the entire large quartz particulates 102 may be substituted with glass or ceramic particulates.

The percentage of the exposed top flat surface section area of the quartz particulates 102, when compared to the binder 106 matrix is very high, for example, greater than 80%. Such a high coverage of area of polished quartz particulates 102 results in a surface with scratch resistance and improved aesthetic appeal resulting from the transparency and visual depth of the large quartz particulates 102. The short fiber reinforced artificial stone laminate 100 disclosed herein is thin, flexible, and lightweight and is used as an architectural surfacing material. Examples of the application of the short fiber reinforced artificial stone laminate 100 disclosed herein comprise the surfacing of kitchen countertops, wall claddings, doors, tabletops, wardrobes, shelves, work-tops, counters, wall linings, column claddings, storage units, lift linings, store fittings, displays, vanity units, cubicles, check out desks, office partitions, and other home and office furniture.

The following example illustrates a method of manufacturing and the composition of a short fiber reinforced artificial stone laminate 100. A mix of particulates 102 of substantially a single size with the size of the mix of the particulates 102 ranging between 1.4 mm to 1.6 mm is deposited on a release surface 201, for example, a silicone rubber sheet of size 4 ft×8 ft placed on a metal work bench. The particulates 102 comprise 80% transparent quartz, 19% colored glass chips, and 1% aluminum coated glass chips. The aluminum coated glass chips provide a reflective shine to the short fiber reinforced artificial stone laminate 100. A single layer 101 of particulates 102 is deposited on the silicone rubber sheet placed on the metal work bench and the metal work bench is gently vibrated with an asymmetrically loaded shaft of a motor until the particulates 102 are packed together, and touch one another adjacently. Vertical overlap of the particulates 102 is avoided. The vertical overlap of the particulates 102 would undesirably result in a thicker and uneven section. Short glass fibers 103 of length 3 mm are deposited in the grooves 107 between the particulates 102. A layer 104 of long reinforcing fibers 105, for example, a chopped strand mat of density 900 grams per square meter is deposited on the short glass fibers 103 and the particulates 102. A binder 106 comprising 75% isothalic neo pentyl glycol polyester resin, 20% styrene, 3% black pigment, 2% methyl ethyl ketone peroxide (MEKP) catalyst, and 0.2% dimethyl aniline (DMA) is deposited on the particulates 102 by either spraying or resin transfer molding. Aluminum trihydrate, to the extent of 30% by weight of the resin, is mixed into the binder 106. Vacuum is applied to the deposited binder 106, the single layer 101 of particulates 102, and the layer 104 of long reinforcing fibers 105 after the deposition of the binder 106, for example, by enveloping the particulates 102, the binder 106, and the long reinforcing fibers 105 in a vacuum bag. After the mix cures, the cured composite is polished using diamond polishing bricks, until the substantially largest area of the particulates 102 is exposed. This results in a short fiber reinforced artificial stone laminate 100 of an approximate thickness of 1.5 mm.

The foregoing examples have been provided merely for the purpose of explanation and are in no way to be construed as limiting of the invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A short fiber reinforced artificial stone laminate, comprising:
a top layer of particulates;
short fibers deposited in grooves between said particulates;
a rear layer of long reinforcing fibers backing said particulates and said short fibers; and
a binder binding said particulates, said short fibers, and said long reinforcing fibers.

2. The short fiber reinforced artificial stone laminate of claim 1, wherein said particulates are of substantially a single size, wherein size deviation from said single size of said particulates is restricted to plus or minus 40%.

3. The short fiber reinforced artificial stone laminate of claim 2, wherein said single size of said particulates is chosen between about 0.5 mm and about 3 mm.

4. The short fiber reinforced artificial stone laminate of claim 1, wherein said binder is a polyester resin with a filler.

5. The short fiber reinforced artificial stone laminate of claim 1, wherein each of said short fibers is of a length between about 1 mm and about 6 mm.

6. The short fiber reinforced artificial stone laminate of claim 1, wherein said long reinforcing fibers are configured as a chopped glass fiber mat.

7. The short fiber reinforced artificial stone laminate of claim 1, wherein said long reinforcing fibers are configured as a knitted glass fiber yarn.

8. The short fiber reinforced artificial stone laminate of claim 1, wherein said particulates comprise quartz particulates.

9. The short fiber reinforced artificial stone laminate of claim 1, wherein said short fibers comprise short glass fibers.

10. The short fiber reinforced artificial stone laminate of claim 1, wherein said particulates comprise one or more of quartz particulates, metal pieces, transparent particulates coated with metal and colored glass, and any combination thereof.

11. A method for manufacturing a short fiber reinforced artificial stone laminate, comprising:
depositing particulates on a release surface;
depositing short fibers in grooves between said particulates;
vibrating said particulates and said short fibers, whereby said short fibers align and position themselves in said grooves between said particulates;
depositing long reinforcing fibers on said particulates; and
depositing a binder for binding said particulates, said short fibers, and said long reinforcing fibers.

12. The method of claim 11, further comprising applying vacuum and pressure to said deposited binder, said particulates, and said long reinforcing fibers during and/or after said deposition of said binder.

13. The method of claim 11, further comprising chemically modifying a surface of said particulates for improved adhesion of said particulates with said binder.
